(19) United States
(12) Patent Application Publication
(10) Pub. No.: US 2013/0226784 A1
(43) Pub. Date: Aug. 29, 2013

(54) SYSTEM AND METHOD FOR CREDIT BALANCE TRANSFER OFFER OPTIMIZATION

(71) Applicants: Vincent He, Naperville, IL (US); Jun Yang, Vernon Hills, IL (US); Yanqing Jiang, Shanghai (CN); Dong Yan, Buffalo Grove, IL (US); Yanguo Wang, Buffalo Grove, IL (US)

(72) Inventors: Vincent He, Naperville, IL (US); Jun Yang, Vernon Hills, IL (US); Yanqing Jiang, Shanghai (CN); Dong Yan, Buffalo Grove, IL (US); Yanguo Wang, Buffalo Grove, IL (US)

(73) Assignee: Discover Financial Services, Riverwoods, IL (US)

(21) Appl. No.: 13/407,093

(22) Filed: Feb. 28, 2012

(51) Int. Cl. G06Q 40/02

(52) U.S. Cl. 705/38

(57) ABSTRACT

A computer based method for selecting a balance transfer pricing offer for an individual financial account. The method includes selecting a plurality of balance transfer offers, each balance transfer offer comprising balance transfer pricing and duration criteria, executing computer executable instructions comprising one or more predictive models that estimate for the individual financial account and each of the balance transfer offers a plurality of parameters such as a probability of a response as well as a plurality of financial parameters, scoring the estimate of the one or more predictive models to determine an expected financial benefit for each of the balance transfer offers, determining, for the individual financial account, an optimal balance transfer offer among the plurality of the balance transfer offers by way of maximizing the expected financial benefit based on a plurality of constraints, and assigning to the individual financial account the optimal balance transfer offer.

### FIELD OF THE INVENTION

This patent disclosure relates generally to electronic financial systems and more particularly to electronic credit balance transfer management systems.

### BACKGROUND OF THE INVENTION

Conventional credit balance transfer offers are priced on a consumer population group level, where a particular segment of a consumer population is associated with a balance transfer offer. For instance, conventional balance transfer offers may be determined at group level by a credit risk score and historical balance transfer credit performance associated with a particular consumer population segment. Consequently, the credit providers are not able to tailor balance transfer offers and/or optimize a net financial benefit of a particular balance transfer offer on an individual account level. Instead, historical profits per population segment are used to gauge the success of past balance transfer campaigns after implementation. This is problematic not only because it requires an expense of implementing a marketing campaign, but also because the specific nature of credit balance transfers does not lend itself well to population group level analysis due to a variety of short-term factors that may differently affect balance transfer credit performance on an individual account basis. Such short-term factors specific to balance transfer credit performance may include, for example, temporary employment difficulties, such as those during the periods of economic recession, as well as other economic factors affecting consumer balance transfer creditworthiness, including but not limited to customer delinquency status, recent payments, and recent spending.

Thus, a new approach is needed to address the foregoing deficiencies of the conventional balance transfer offer design and implementation.

It will be appreciated that this background description has been created by the inventor to aid the reader, and is not to be taken as a reference to prior art nor as an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of the claimed invention to solve any specific problem noted herein.

### SUMMARY OF THE INVENTION

In one aspect of the invention, a computer-based method for selecting an optimum balance transfer pricing offer for an individual financial account is provided. The method executed by a computer processor and comprising selecting a plurality of balance transfer pricing offers, each balance transfer pricing offer comprising balance transfer pricing and duration criteria, the processor executing computer executable instructions stored in non-transitory computer readable memory, the instructions comprising one or more predictive models adapted to estimate for the individual financial account and each of the balance transfer pricing offers one or more of: a probability of a response to the offer, an amount of a balance subject to transfer, a monthly payment in connection with the amount of the transfer at least one of before and after a promotional period associated with the balance transfer offer, cost associated with the balance transfer offer, and a likelihood of a charge-off event associated with the individual financial account. The method further comprising scoring the estimate of the one or more predictive models so as to determine an expected financial benefit for each of the balance transfer pricing offers, determining, for the individual financial account, the optimal balance transfer pricing offer among the plurality of the balance transfer pricing offers by way of maximizing the expected financial benefit based on a plurality of constraints, and assigning to the individual financial account the optimal balance transfer offer.

In another aspect of the invention, a non-transitory computer readable medium is provided. The computer readable medium storing thereon computer executable instructions for selecting an optimum balance transfer pricing offer for an individual financial account. The instructions comprising selecting a plurality of balance transfer pricing offers, each balance transfer pricing offer comprising balance transfer pricing and duration criteria, executing instructions comprising one or more predictive models adapted to estimate for the individual financial account and each of the balance transfer pricing offers one or more of: a probability of a response to the offer, an amount of a balance subject to transfer, a monthly payment in connection with the amount of the transfer at least one of before and after a promotional period associated with the balance transfer offer, cost associated with the balance transfer offer, and a likelihood of a charge-off event associated with the individual financial account. The instructions further comprise scoring the estimate of the one or more predictive models so as to determine an expected financial benefit for each of the balance transfer pricing offers, determining, for the individual financial account, the optimal balance transfer pricing offer among the plurality of balance transfer pricing offers by way of maximizing the expected financial benefit based on a plurality of constraints, and assigning to the individual financial account the optimal balance transfer pricing offer.

In yet another aspect of the invention, a computer-based method for selecting an optimum balance transfer pricing offer for an individual financial account is provided. The method executed by a computer processor and comprising selecting a plurality of balance transfer pricing offers, each balance transfer pricing offer comprising balance transfer pricing and duration criteria, the processor executing computer executable instructions stored in non-transitory computer memory, the instructions comprising one or more predictive models adapted to estimate for the individual financial account and each of the balance transfer offers a plurality of parameters including financial parameters. The method further comprising scoring the estimate of the one or more predictive models so as to determine an expected financial benefit for each of the balance transfer offers, determining, for the individual financial account, the optimal balance transfer pricing offer among the plurality of balance transfer pricing offers by way of maximizing the expected financial benefit based on a plurality of constraints, and assigning to the individual financial account the optimal balance transfer offer.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram showing a computerized system for credit balance transfer offer optimization, in accordance with an embodiment of the invention;

FIG. 2 is a flow chart illustrating a process for determining an optimal set of parameters for a balance transfer offer on an individual account basis, in accordance with an embodiment of the invention; and

FIG. 3. is a flow chart illustrating the process of FIG. 2 in further detail, in accordance with an embodiment of the invention.

### DETAILED DESCRIPTION OF THE INVENTION

The following examples further illustrate the invention but, of course, should not be construed as in any way limiting its scope.

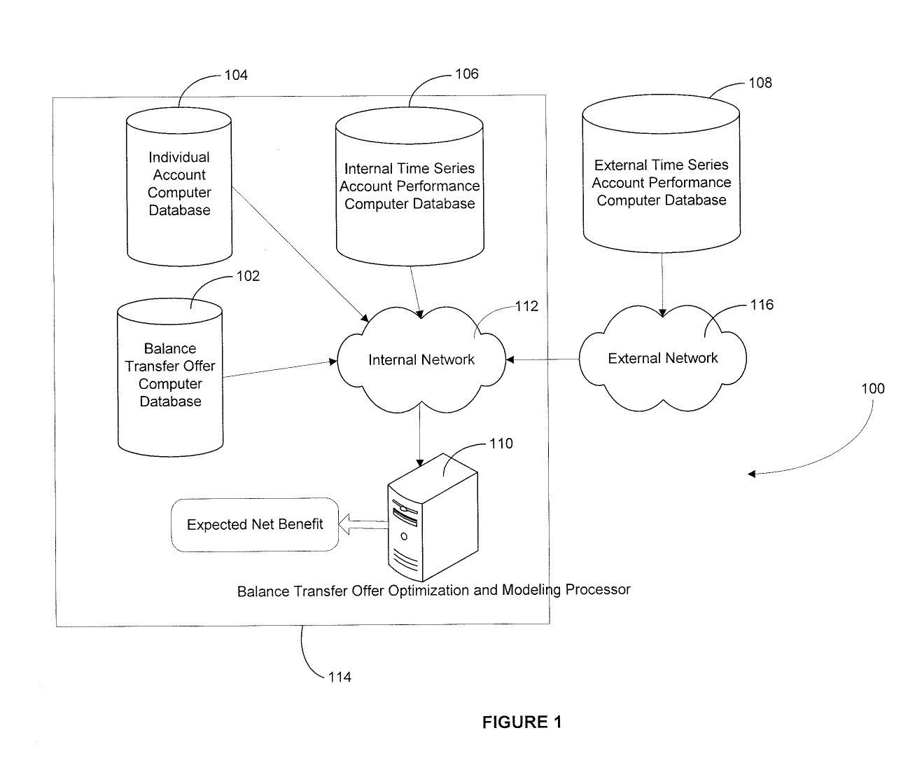

Turning to FIG. 1, an embodiment of a computerized system for credit balance transfer offer optimization is shown. The system 100 includes a plurality of databases 102-108 communicatively coupled to a balance transfer offer optimization and modeling computer processor 110. In an embodiment, the processor 110 is coupled to a balance transfer offer database 102, individual account database 104, and internal time series account performance database 106 via an internal network 112, such as a local area network (LAN) and/or a wide area network (WAN) interconnecting a credit issuer's 114 enterprise computer system. In the illustrated embodiment, the processor 110 is further coupled to an external time series account performance database 108 (e.g., a credit bureau database) via an external computer network 116, such as the Internet, a WAN, or the like. Databases 102-108 include computer processors, as well non-transitory computer readable media, such as hard drive, flash, RAM, and ROM memory or the like, for aggregating and storing credit balance transfer performance, account, and balance transfer offer information. In an embodiment, databases 102-108 are implemented via one or more corresponding special-purpose computer database servers.

The balance transfer offer database 102 stores a plurality of balance transfer pricing parameters corresponding to multiple balance transfer offers. A given set of pricing parameters corresponding to a balance offer comprises balance transfer fee parameters, including any associated interest and transfer charges during and after a promotional period (e.g., including a promotional Annual Percentage Rate (APR) as well as a “go-to” APR in effect after the promotional period), and promotional pricing duration. The individual account database 104 stores account information relating to existing customer credit accounts of the credit card issuer 114, while the internal time series account performance database 106 includes information on balance transfer credit performance of corresponding individual accounts (e.g., balance transfer payment history, including days past-due, and average balance). Finally, the external time series account performance database 108 stores balance transfer credit performance history of a consumer population that includes prospective customers of the credit issuer 114.

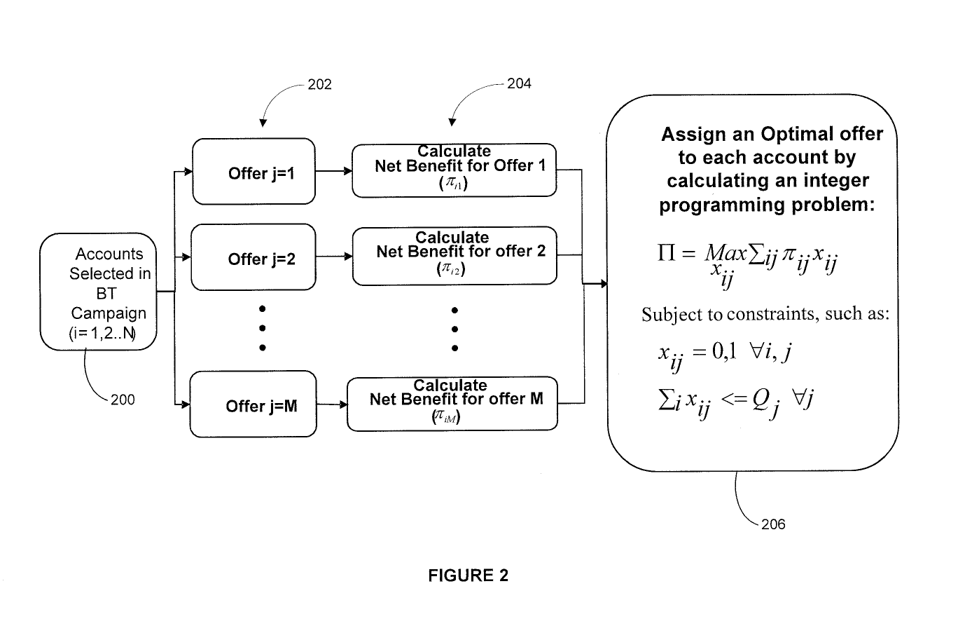

Turning to FIG. 2, an embodiment of a process for determining an optimal set of parameters for a balance transfer offer on an individual account basis is shown. The balance transfer offer optimization and modeling processor 110 performs an offer parameter optimization process comprising the following steps. First, a net financial benefit of the balance transfer (BT net benefit) that is indicative of profitability to the issuer 114 is determined at a customer account level for a given balance transfer pricing offer having a particular set of parameters. The balance transfer parameters include a promotional transfer fee (if any), a promotional APR, a promotional pricing duration, and a “go-to” APR (e.g., an APR that takes effect after the promotional fee period). The processor 110 selects N number of customer accounts i for processing, step 200. Next, in steps 202-204, for each account i, the processor 110 calculates a BT net benefit for each offer/set of parameters j (from a plurality of M offers). The calculation for each customer account i with a given offer j is expressed as Equation (1) below.

πᵢⱼ=\hat{p}ᵢⱼ^{BT}×\hat{π}ᵢⱼ|_{BT Ta ker} Equation (1):

where:

\hat{p}ᵢⱼ^{BT}=f(offerⱼ, dvᵢ₁, . . . , dvᵢₖ, evᵢ₁, . . . , evᵢₛ)

\hat{π}ᵢⱼ|_{BT Ta ker}=g(offerⱼ, bt_volumeᵢⱼ, paymentᵢⱼ, spendᵢⱼ, coᵢⱼ)

bt_volumeᵢⱼ=g₁(offerⱼ, dvᵢ₁, . . . , dvᵢₖ_{₁}, evᵢ₁, . . . , evᵢₛ_{₁})

paymentᵢⱼ=g₂(offerⱼ, dvᵢ₁, . . . , dvᵢₖ_{₂}, evᵢ₁, . . . , evᵢₛ_{₂})

spendᵢⱼ=g₃(offerⱼ, dvᵢ₁, . . . , dvᵢₖ_{₃}, evᵢ₁, . . . , evᵢₛ_{₃})

coᵢⱼ=g₄(offerⱼ, \hat{p}ᵢⱼ^{CO}, uᵢⱼ^{CO})

\hat{p}ᵢⱼ^{CO}=g₅(offerⱼ, dvᵢ₁, . . . , dvᵢₖ_{₅}, evᵢ₁, . . . , evᵢₛ_{₅})

uᵢⱼ^{CO}=g₆(offerⱼ, dvᵢ₁, . . . , dvᵢₖ_{₆}, evᵢ₁, . . . , evᵢₛ_{₆})

The probability of a balance transfer for a particular account is given by the \hat{p}ᵢⱼ^{BT} equation. The function ƒ (*) is a logistic regression. A balance transfer benefit for a particular account is given by the \hat{π}ᵢⱼ|_{BT Ta ker} equation. The function g(*) is a non-linear function of pricing offers, predicted balance transfer (bt) volume, predicted payment, predicted merchandise spend, and predicted charge-off amount. The function g(*) may involve a logistic function, log function, polynomial function and/or linear function depending on the particular calculation. For example, payment and spending prediction functions may use log functions.

Predicted BT volume is the estimated balance transfer amount a customer is likely to take. Predicted spend is the estimated merchandise purchase in the future for a particular customer. Predicted payment is the estimated average monthly payment from the customer on the outstanding total balance which could include BT balance, merchandise balance, or cash balance. The attribute set {dvᵢ₁, . . . , dvᵢₖ} corresponds to credit issuer's 114 internal twelve (12) month cycle-based performance time series attributes received from the database 106 (FIG. 1) and the attribute set {evᵢ₁, . . . , evᵢₛ} corresponds to external credit bureau twelve (12) month time series attributes received from the database 108 (FIG. 1). The internal performance may include all balances, payment, and/or delinquency information on a card or account associated with a customer. An external information may contain additional aggregated credit information associated with a customer from lenders including, but not limited to, bank cards, personal loans, mortgages and auto loans. The predicted charge off amount is coᵢⱼ and \hat{p}ᵢⱼ^{CO} is the probability of a charge off for a particular account. The ratio of total charge off amount to an account credit limit is given by uᵢⱼ^{CO}.

Table 1 below sets forth an embodiment of variables used for attribute sets {dvᵢ₁, . . . , dvᵢₖ} and {evᵢ₁, . . . , evᵢₛ} in the context of predictive modeling associated with Equation 1.

TABLE 1
(List of Variables Used in the Models)

| Source | Variable Description |
|---|---|
| CB | Number of open bank and retail revolving trades |
| | with balance to max(high credit, credit limit) ratio |
| | >75% and reported in the last 6 months |
| CB | Ratio of Balance to High Credit for All Open |
| | Revolving Trades |
| CB | Average balance of all open bankcard trades, |
| | maximum month-over-month decrease |
| CB | Maximum # of months highest bank card balance |
| | consecutively increased in last 12 M |
| Issuer | Trend of 12 months in ratio of balance to credit |
| | line |
| Issuer | Offer pricing - “go-to” APR |
| Issuer | Three month average in ratio of balance to credit |
| | line |
| Issuer | Balance Transfer (BT) transaction amount in the |
| | past 70 days |
| Issuer | Average net payment in the past 12 months |
| Issuer | Number of merchant activities in the past 3 |
| | months |
| Issuer | Total current principal balance |
| Issuer | BT transaction amount in the past 70 days |
| Issuer | Average merchant sale amount in the past 3 |
| | months |
| Issuer | Total Non-sufficient-fund fee charged in last 12 M |
| Issuer | Cycle open to buy amount in current month |
| Issuer | Average payment activity amount in last 12 M |
| Issuer | Average merchandise sales activity amount in last |
| | 12 M |
| Issuer | Maximum # of months merchandise sales |
| | increase amount in last 3 M |
| Issuer | Offer pricing - duration |
| Issuer | Offer pricing - BT fee rate |
| Issuer | Offer pricing - promo APR |

In Table 1, “CB” stands for Credit Bureau data, for example received from the external time series performance database 108. “Issuer” variables in Table 1 are sourced from one or more databases associated with the issuer 114.

Next, in step 206, the processor 110 determines an optimal set of balance transfer pricing parameters for each customer account among a plurality of M balance transfer offers. Specifically, the processor 110 solves a campaign optimization problem by defining an objective function of the optimization along with the global and local constraints, as further described below. Once the processor 110 determines the optimal set of balance transfer offer parameters for each individual potential account, such offer is assigned to the account for roll out as part the issuer's marketing campaign.

By way of example, a hypothetical set of balance transfer offer pricing parameters is discussed below. For ease of illustration, only two sets of parameters (M=2) are described below, however those having ordinary skill in the art will realize that the following process applies to numerous combinations of pricing parameters. The objective is, for each individual customer account, to select a set of parameters corresponding to one of the following balance transfer pricing offers that maximizes total marketing campaign net benefit (e.g., profitability). In this example, the following two balance transfer offers are evaluated: (1) BT Fee=4%, Promotional Period=12 Months, Go-to Rate=14.99%, and (2) BT Fee=3%, Promotional Period=6 Months, Go-to Rate=16.99%.

Number of BT Qualified Customers=1 million (1 MM).

Offer Allocation Constraints: The number of accounts with Offer (2) is less than or equal to four hundred thousand (400K). Each account can only get one and only one offer. Generally, embodiments of the offer allocation constraints include a predetermined maximum number of balance transfer pricing offers to be extended to each individual financial account and/or a predetermined maximum number of individual financial accounts assigned to each balance transfer pricing offer.

An integer programming problem is setup to optimize the offer campaign to match most profitable balance transfer offers with individual customer accounts. In this example, the formula to maximize balance transfer campaign profitability by way of a Total Net Balance Transfer (BT) Benefit is given mathematically as follows:

$$Π = {Max}_{{x}_{ij}} {\sum }_{ij} {π}_{ij } {x}_{ ij}$$

Subject to

xᵢⱼ=0,1 ∀i=1, 2, . . . , 1 MM and j=1, 2

Σixᵢ₂<=400 K

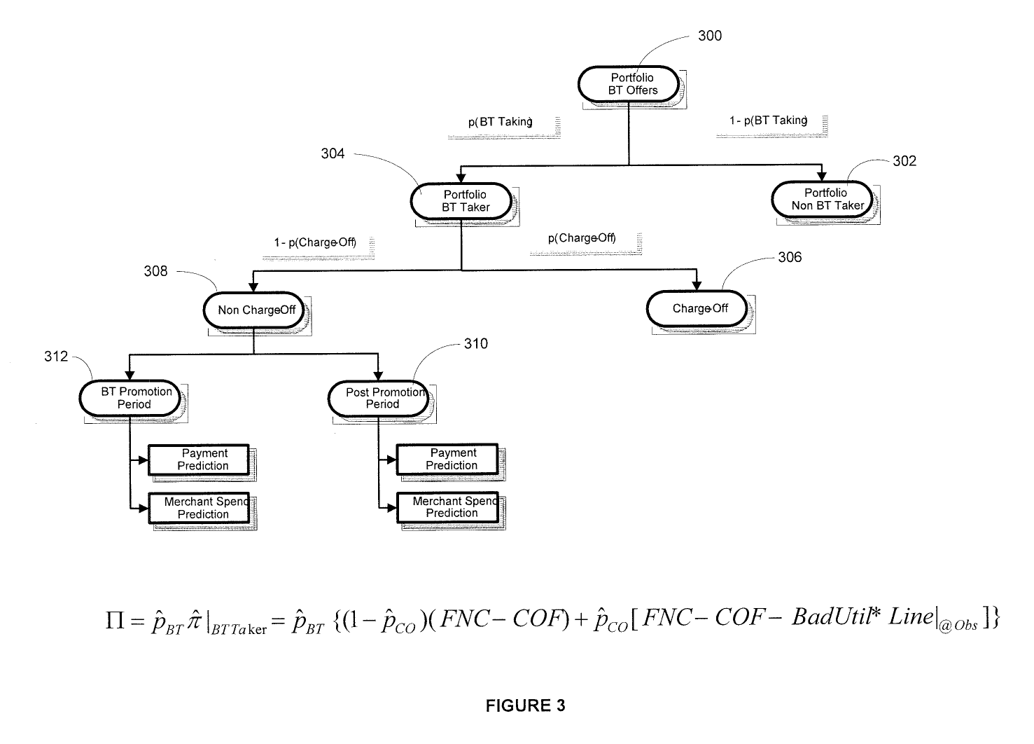

The processor 110 then proceeds to execute the optimization process as further discussed below in connection with FIG. 3.

Turning to FIG. 3, an embodiment of a process of FIG. 2 is shown in further detail. In steps 300-304, the processor 110 selects a plurality of balance transfer (BT) pricing offers and determines a probability that a prospective customer will respond to one of the selected BT offers. Next, in steps, 306-308, for the subset of prospective accounts that were estimated as being likely to respond to one of the BT offers, the processor 110 estimates the probability that a given prospective account will have a charge off event due to inability to re-pay the transferred balance. In steps 310-312, the processor 110 executes models that predict payment and merchant spending amounts during and after balance transfer promotional period. The processor 110 uses the output of the foregoing steps as an input to the integer optimization algorithm to select for each individual account the pricing offer that maximizes the net financial benefit to the credit card issuer 114, as discussed above in connection with FIG. 2. In an embodiment, the net benefit of each BT pricing offer is represented as a score. In one embodiment, the score calculation is based on the πᵢⱼ calculation. Embodiments of predictive models executed by the processor 110 in connection with the foregoing steps 300-312 are illustrated in Tables (2) and (3) below.

TABLE (2)
(Predictive Model Embodiments)

| Predictive Models/ | |
|---|---|
| Processes | Descriptions |
| Charge-Off Model | Predicts the probability of a BT taker to become charge-off and/or |
| | bankruptcy within the next 12 months |
| Bad Utilization | Predicts the ratio of charge-off balance to credit limit for each charge- |
| Model | off account within the next 12 months |
| Spending Models | Predicts the average merchant spends of a BT taker before and after the |
| | BT promotional periods |
| Payment Models | Predicts the average payments of a BT taker before and after the BT |
| | promotional periods |
| BT Volume | Predicts the BT amount given response and pricing offers |
| Model | |
| BT Response | Predicts the probability of an account responding to a given BT offer |
| Model | |
| Profitability | Finance charges from each component of balance including BT, |
| estimates for each | merchandise, cash, and expired BT are calculated under the pre-CARD |
| accounts under | Act Payment hierarchy due to the APR differences. The total charge- |
| pre-CARD act | off balance is estimated as the probability of charge-off multiplying by |
| | credit limit and bad utilization prediction. The net benefit estimate for |
| | each account is the total finance charges plus BT fee less the total |
| | charge-off balance. |
| Profitability | Finance charges from each component of balance including BT, |
| estimates for each | merchandise, cash, and expired BT are calculated under the post- |
| accounts under | CARD Act payment hierarchy due to the APR differences. Total |
| post-CARD act | charge-off balance is estimated as the probability of charge-off |
| | multiplying by credit limit and bad utilization prediction. The net |
| | benefit estimates for each account is the total finance charge plus BT |
| | fee less the total charge-off balance. |

TABLE (3)
(Predictive Model Embodiments, cont.)

| Predictive | |
|---|---|
| Models/ | |
| Processes | Description |
| Key profitability | There are three key profitability drivers for each |
| drivers estimates | account: finance charges, charge-off amount, and |
| for each accounts | cost of fund. There three key drivers are contributed |
| | by or functions of four key customer behaviors: |
| | response, payment, spend, and charge-off. |
| | The predictive models are used to predict |
| | those four key customer behaviors to drive |
| | profitability for any given BT offers. |
| Integrated view of | The BT Net Benefit Framework provides an |
| BT offer | integrated view of account level net benefits |
| profitability | based on any given BT offers. This sets for |
| | the foundation of individual level pricing optimization |
| | process for all BT campaigns to maximize net |
| | benefit under certain global and individual constraints. |
| Optimal BT offer | For each of the BT campaign, an optimal BT offer |
| for each account | can be determined by using this framework along |
| | with the described optimization process to |
| | maximize total net benefit under global and |
| | individual constraints. |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-based method for selecting an optimum balance transfer pricing offer for an individual financial account, the method executed by a computer processor and comprising:
selecting a plurality of balance transfer pricing offers, each balance transfer pricing offer comprising balance transfer pricing and duration criteria;
estimating, using the processor executing computer executable instructions stored in non-transitory computer readable memory, the instructions comprising one or more predictive models adapted to estimate for the individual financial account and each of the balance transfer pricing offers, one or more of:
a probability of a response to the offer,
an amount of a balance subject to transfer,
a monthly payment in connection with the amount of the transfer at least one of before and after a promotional period associated with the balance transfer offer,
cost associated with the balance transfer offer, and
a likelihood of a charge-off event associated with the individual financial account;
scoring the estimate of the one or more predictive models so as to determine an expected financial benefit for a issuer for each of the balance transfer pricing offers;
determining, for the individual financial account, an optimal balance transfer pricing offer among the plurality of the balance transfer pricing offers by way of maximizing the expected financial benefit to the issuer based on a plurality of constraints; and
assigning to the individual financial account the optimal balance transfer offer.

2. The method of claim 1 wherein maximizing the expected financial benefit based on a plurality of constraints comprises performing integer programming optimization to determine an optimal balance transfer pricing offer for the individual financial account.

3. The method of claim 2 wherein the integer programming optimization complies with a following formula:
$$Π = {Max}_{{x}_{ij}} {\sum }_{ij} {π}_{ij } {x}_{ ij}$$
wherein the plurality of constraints comprise:
xᵢⱼ=0,1 ∀i, j
Σixᵢⱼ<=Qⱼ ∀J,
where:
Qⱼ is a number of individual financial accounts corresponding to a particular balance transfer pricing offer.

4. The method of claim 3 wherein the plurality of constraints further comprise a predetermined maximum number of balance transfer pricing offers to be extended to each individual financial account.

5. The method of claim 3 wherein the plurality of constraints further comprise a predetermined maximum number of individual financial accounts assigned to the balance transfer pricing offer.

6. The method of claim 1 wherein the balance transfer pricing and duration criteria are selected from the group consisting of: balance transfer interest charges, charges for transferring a balance, a promotional Annual Percentage Rate (APR), an APR in effect after a promotional period, and promotional pricing duration.

7. A non-transitory computer readable medium having stored thereon computer executable instructions for selecting an optimum balance transfer pricing offer for an individual financial account, the instructions comprising:
selecting a plurality of balance transfer pricing offers, each balance transfer pricing offer comprising balance transfer pricing and duration criteria;
executing instructions comprising one or more predictive models adapted to estimate for the individual financial account and each of the balance transfer pricing offers one or more of:
a probability of a response to the offer,
an amount of a balance subject to transfer,
a monthly payment in connection with the amount of the transfer at least one of before and after a promotional period associated with the balance transfer offer,
cost associated with the balance transfer offer, and
a likelihood of a charge-off event associated with the individual financial account;
scoring the estimate of the one or more predictive models so as to determine an expected financial benefit for an issuer for each of the balance transfer pricing offers;
determining, for the individual financial account, an optimal balance transfer pricing offer among the plurality of balance transfer pricing offers by way of maximizing the expected financial benefit to the issuer based on a plurality of constraints; and
assigning to the individual financial account the optimal balance transfer pricing offer.

8. The computer readable medium of claim 7 wherein maximizing the expected financial benefit based on a plurality of constraints comprises performing integer programming optimization to determine the optimal balance transfer pricing offer for the individual financial account.

9. The computer readable medium of claim 8 wherein the integer programming optimization complies with a following formula:
$$Π = {Max}_{{x}_{ij}} {\sum }_{ij} {π}_{ij } {x}_{ ij}$$
wherein the plurality of constraints comprise:
xᵢⱼ=0,1 ∀i, j
Σixᵢⱼ<=Q_{J} ∀J,
where:
Qⱼ is a number of individual financial accounts corresponding to a particular balance transfer pricing offer.

10. The computer readable medium of claim 9 wherein the plurality of constraints further comprise a predetermined maximum number of balance transfer pricing offers to be extended to each individual financial account.

11. The computer readable medium of claim 9 wherein the plurality of constraints further comprise a predetermined maximum number of individual financial accounts assigned to the balance transfer pricing offer.

12. The computer readable medium of claim 7 wherein the balance transfer pricing and duration criteria are selected from the group consisting of: balance transfer interest charges, charges for transferring a balance, a promotional Annual Percentage Rate (APR), an APR in effect after a promotional period, and promotional pricing duration.

13. A computer-based method for selecting an optimum balance transfer pricing offer for an individual financial account, the method executed by a computer processor and comprising:
selecting a plurality of balance transfer pricing offers, each balance transfer pricing offer comprising balance transfer pricing and duration criteria;
estimating, using the processor executing computer executable instructions stored in non-transitory computer memory, the instructions comprising one or more predictive models adapted to estimate for the individual financial account and each of the balance transfer offers, a plurality of parameters including financial parameters;
scoring the estimate of the one or more predictive models so as to determine an expected financial benefit for an issuer for each of the balance transfer offers;
determining, for the individual financial account, an optimal balance transfer pricing offer among the plurality of balance transfer pricing offers by way of maximizing the expected financial benefit to the issuer based on a plurality of constraints; and
assigning to the individual financial account the optimal balance transfer offer.

14. The method of claim 13 wherein the financial parameters are selected from the group consisting of: an amount of a balance subject to transfer, a monthly payment in connection with the amount of the transfer at least one of before and after a promotional period associated with the balance transfer pricing offer, cost associated with the balance transfer offer, and a likelihood of a charge-off event associated with the individual financial account.

15. The method of claim 13 wherein the plurality of parameters further comprise a probability of a response to the offer.

16. The method of claim 13 wherein maximizing the expected financial benefit based on a plurality of constraints comprises performing integer programming optimization to determine the optimal balance transfer pricing offer for the individual financial account.

17. The method of claim 16 wherein the integer programming optimization complies with a following formula:
$$Π = {Max}_{{x}_{ij}} {\sum }_{ij} {π}_{ij } {x}_{ ij}$$
wherein the plurality of constraints comprise:
xᵢⱼ=0,1 ∀i, j
Σixᵢⱼ<=Qⱼ ∀J,
where:
Qⱼ is a number of individual financial accounts corresponding to a particular balance transfer pricing offer.

18. The method of claim 17 wherein the plurality of constraints further comprise a predetermined maximum number of balance transfer pricing offers to be extended to each individual financial account.

19. The method of claim 17 wherein the plurality of constraints further comprise a predetermined maximum number of individual financial accounts assigned to the balance transfer pricing offer.

20. The method of claim 13 wherein the balance transfer pricing and duration criteria are selected from the group consisting of balance transfer interest charges, charges for transferring a balance, a promotional Annual Percentage Rate (APR), an APR in effect after a promotional period, and promotional pricing duration.
